(19) United States
(12) Patent Application Publication
(10) Pub. No.: US 2003/0057105 A1
(43) Pub. Date: Mar. 27, 2003

(54) Compositions containing aqueous basic saturated solutions of zinc oxide and processes for preparing said solutions and zinc metal

(75) Inventors: Baldev K. Bandlish, Charlotte, NC (US); Vincent Wise Martin, Gastonia, NC (US)

Correspondence Address: CLARIANT CORPORATION, Industrial Property Department, 4331 Chesapeake Drive, Charlotte, NC, 28216, US

(73) Assignee: Clariant International Ltd.

(21) Appl. No.: 09/965,157

(22) Filed: Sep. 27, 2001

(51) Int. Cl. C25C 1/16; C01G 9/02

(52) U.S. Cl. 205/602; 423/622

(57) ABSTRACT

The present invention provides a composition comprising a saturated solution of zinc oxide in an aqueous sodium or potassium hydroxide solution wherein the concentrations of the zinc oxide and the sodium hydroxide in said solution are as set forth in FIG. 1, and the concentrations of the zinc oxide and potassium hydroxide are as set forth in FIG. 2. The present invention also provides a process for preparing a solution of zinc oxide in an aqueous base, said process comprising diluting a more concentrated solution of zinc oxide in aqueous sodium or potassium hydroxide to produce a resulting dilute solution of zinc oxide having a concentration of zinc oxide that is higher than that obtained by dissolving solid zinc oxide in aqueous sodium or potassium hydroxide, wherein the concentration of the aqueous sodium or potassium hydroxide used for dissolving the solid zinc oxide is substantially the same as the concentration of the aqueous sodium or potassium hydroxide in the resulting dilute solution of zinc oxide, and wherein the concentration of the aqueous sodium hydroxide in the resulting dilute solution ranges from 5 wt % NaOH to about 35 wt % NaOH, and the concentration of the aqueous potassium hydroxide in the resulting dilute solution ranges from 10 wt % KOH to about 55 wt % KOH. The present invention also provides a process for producing zinc metal comprising electrolyzing a basic solution of zinc oxide prepared by the aforementioned process.

### FIELD OF THE INVENTION

The present invention provides a composition comprising a saturated solution of zinc oxide in an aqueous base, a process for preparing a solution of zinc oxide in aqueous base, and a process for producing zinc metal.

### BACKGROUND OF THE INVENTION

Zinc powder is widely used in various industries. Zinc oxide containing other zinc salts, metal impurities, etc. is produced as a byproduct. Recycling of the zinc oxide to produce pure zinc powder is highly desirable from a cost as well as an environmental point of view.

The electrodeposition of zinc metal is a well-known reaction in electrochemical technology (See, for example, D. Pletcher and F. C. Walsh, Industrial Electrochemistry, Blackie Academic, 1993). The electrogalvanizing of steel is a process carried out on a very large scale and aqueous acid is the normal medium. High speed, reel-to-reel galvanizing of steel is carried out in sulfuric acid with dimensionally stable anodes and uniform deposition is achieved at high current density by inducing very efficient mass transport by rapid movement of the steel surface. The deposition of zinc metal is also the critical electrode reaction in the electrowinning and electrorefining of zinc. In addition, there are a number of technologies, which have been demonstrated for the removal of Zn(II) from effluents. However, in these technologies, concentration of Zn(II) is low, commonly less than 100 ppm. Finally, the deposition of zinc has been widely investigated as the cathodic reaction in candidate secondary batteries. In all these applications, however, the objective is to select the conditions so as to give an adhesive and smooth zinc coating.

Zinc metal can be produced by electrolysis either in strong alkaline or neutral zinc containing solutions. The first patents obtained on the alkaline electrolysis process date back to the early thirties (German Patents, 581013, 506590, 653557). In these methods, a low current density of 1200-1500 amperes/sq. meter (A/m²) was used. Volume efficiency and current density of these batch type processes are too low to be industrially attractive. I. Orszagh and B. Vass (Hung. J. Ind. Chem., 13, (1985) 287) used these methods to recycle zinc oxide byproduct from zinc dithionite production.

For the recycling of zinc oxide containing waste by an alkaline electrolysis process to be industrially attractive, alkaline electrolysis process needs to be improved to lower capital as well as operational expenses. Typically, the electrolysis of zinc oxide results in low volume efficiency because of the limited solubility of zinc oxide in aqueous base.

The limited solubility of zinc oxide in the aqueous sodium hydroxide solution depends on the temperature and sodium hydroxide concentration. For example, solubility of zinc oxide at a pH of 9.7 is 0.00001 grams per m³ (Zinc Oxide—Properties and Applications, Harvey E. Brown, International Lead Zinc Research Organization, Inc., 1976, page 40). Solubility of zinc oxide in a solution containing 5 wt % sodium hydroxide is 2.1 grams ZnO/kilogram of NaOH solution (2.1 g/kg).

It is therefore highly desirable to increase solubility of zinc oxide in lower sodium hydroxide concentrations so that the electrolytic reduction of zinc oxide to zinc metal can be carried out to achieve higher volume efficiency, while retaining high current efficiency and low anode corrosion. The present invention fulfills these and other needs. An increase in volume efficiency leads to significant savings in equipment costs and processing costs due to improved throughput. Furthermore, raw material savings will be achieved because of the lower usage of sodium hydroxide. Higher current efficiency leads to lower electrochemical equipment cost and lower current cost and hence operational costs. Lower corrosion leads to purer product and lower maintenance costs.

U.S. Pat. No. 5,759,503 discloses a process for the recovery of high purity zinc oxide products, and optionally iron-carbon feedstocks, from industrial waste streams containing zinc oxide and/or iron. The waste streams preliminarily can be treated by adding carbon and an ammonium chloride solution, separating any undissolved components from the solution, displacing undesired metal ions from the solution using zinc metal, treating the solution to remove therefrom zinc compounds, and further treating the zinc compounds and the undissolved components, as necessary, resulting in the zinc products and the optional iron-carbon feedbacks. Once the zinc oxide has been recovered, the purification process is used to further purify the zinc oxide to obtain zinc oxide which is at least 99.8% pure and which has predeterminable purity and particle characteristics. This patent discloses a preferred process wherein zinc oxide is dissolved in a concentrated 50%-70% sodium hydroxide solution. The solution is then filtered and diluted by a factor ranging from 3 to 30, at or above 70° C. to precipitate ZnO.

U.S. Pat. No. 5,958,210 discloses a method for electrowinning metallic zinc from zinc ion in aqueous solution, said method comprising performing electrolysis on a mixture of solid conductive particles and aqueous alkali solution, said solution ranging in concentration from 3N to 20N alkali and containing dissolved zinc ion at an initial concentration ranging from 50 to 500 grams of zinc ion per liter of said solution, in an electrolytic cell containing first and second vertically arranged, parallel flat plates defined as a current feeder and a counter electrode, respectively, said counter electrode coated with a substance that is catalytic for oxygen evolution, said cell further containing an ion-permeable diaphragm parallel to each of said plates and interposed therebetween to define a gap between said current feeder and said diaphragm, by passing said mixture of particles and solution through said gap such that said particles contact said current feeder and passing a current across said gap, thereby depositing metallic zinc from said solution onto said particles.

U.S. patent application Ser. No. 09/776,518 (filed Feb. 2, 2001) discloses the unexpected finding that too high concentration (such as concentration substantially higher than 10 M) of base (e.g., NaOH solution) solution is not desirable for the electrolytic reduction of zinc oxide to zinc metal because of the unexpected adverse effect on corrosion of the stainless steel anode and on the current efficiency of the process where electrolysis is carried out at high current densities (such as higher than 10,000 A/m²). This patent application discloses that the adverse effect is minimized by lowering the aqueous base concentration.

### SUMMARY OF THE INVENTION

The present invention provides a composition comprising a basic saturated solution of zinc oxide in an aqueous sodium or potassium hydroxide solution wherein the concentrations of the zinc oxide and the sodium hydroxide in said solution are as set forth in FIG. 1, and the concentrations of the zinc oxide and potassium hydroxide are as set forth in FIG. 2.

The present invention also provides a process for preparing a solution of zinc oxide in an aqueous base, said process comprising diluting a more concentrated solution of zinc oxide in aqueous sodium or potassium hydroxide to produce a resulting dilute solution of zinc oxide having a concentration of zinc oxide that is higher than that obtained by dissolving solid zinc oxide in aqueous sodium or potassium hydroxide, wherein the concentration of the aqueous sodium or potassium hydroxide used for dissolving the solid zinc oxide is substantially the same as the concentration of the aqueous sodium or potassium hydroxide in the resulting dilute solution of zinc oxide, and wherein the concentration of the aqueous sodium hydroxide in the resulting dilute solution ranges from 5 wt % NaOH to 35 wt % NaOH, and the concentration of the aqueous potassium hydroxide in the resulting dilute solution ranges from 10 wt % KOH to 55 wt % KOH.

The present invention also provides a process for producing zinc metal comprising electrolyzing a basic solution of zinc oxide prepared by the aforementioned process.

### BRIEF DESCRIPTION OF THE DRAWINGS

FIG. 1 is a plot of concentration of zinc oxide solution in aqueous NaOH vs NaOH concentration, the zinc oxide solution prepared by the process of the present invention.

FIG. 2 is a plot of concentration of zinc oxide solution in aqueous KOH vs. KOH concentration, the zinc oxide solution prepared by the process of the present invention.

FIG. 3 is a plot of zinc oxide concentration vs. aqueous NaOH concentration, wherein the zinc oxide solution is prepared both by normal solubilization and by the process of this invention.

FIG. 4 is a plot of zinc oxide concentration vs. aqueous KOH concentration, wherein the zinc oxide solution is prepared both by normal solubilization and by the process of this invention.

### DESCRIPTION OF THE PREFERRED EMBODIMENTS

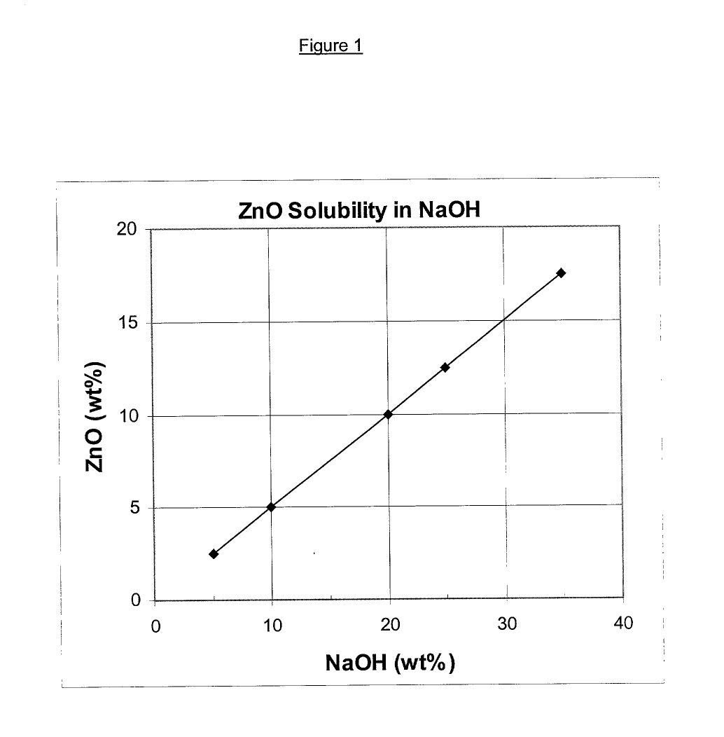

The present invention provides a composition comprising a solution of zinc oxide in an aqueous sodium hydroxide solution wherein the concentrations of the zinc oxide and the sodium hydroxide in said basic solution of zinc oxide are as set forth in FIG. 1.

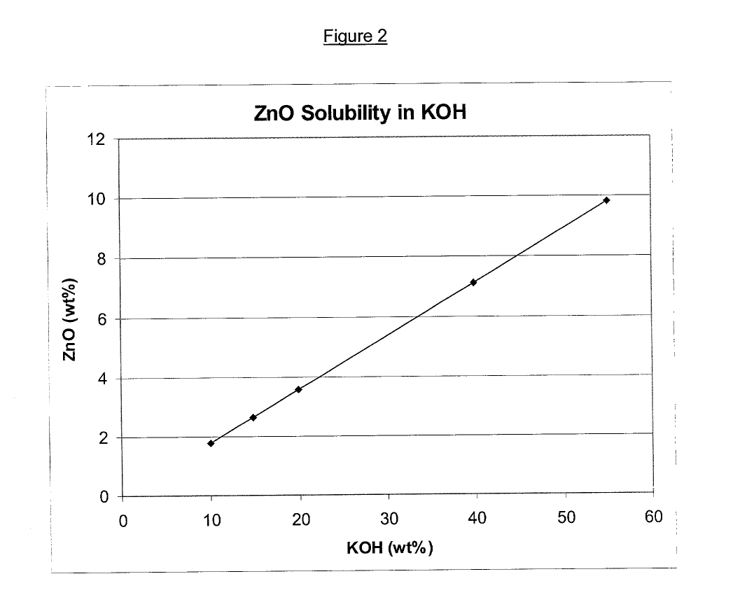

The present invention also provides a composition comprising a solution of zinc oxide in an aqueous potassium hydroxide solution wherein the concentrations of the zinc oxide and the potassium hydroxide in said basic solution of zinc oxide solution are as set forth in FIG. 2.

These compositions are unique and surprising in that they contain more zinc oxide than compositions obtained by dissolving solid zinc oxide in aqueous sodium or potassium hydroxide wherein the concentrations of the aqueous sodium and potassium hydroxide are substantially the same in both the presently claimed compositions and those that can be made directly by dissolving the solid zinc oxide in sodium or potassium hydroxide. As such the presently claimed compositions contain zinc oxide in concentrations greater than saturated solutions that are prepared by normal solubilization by dissolving solid zinc oxide in aqueous sodium or potassium hydroxide.

The presently claimed compositions can be made by diluting a more concentrated solution of zinc oxide (prepared by using a more concentrated base solution) in aqueous sodium or potassium hydroxide.

As such, the present invention also provides a process for preparing a solution of zinc oxide in an aqueous sodium or potassium hydroxide solution, said process comprising diluting a more concentrated solution of zinc oxide in aqueous sodium or potassium hydroxide to produce a resulting dilute solution of zinc oxide having a concentration of zinc oxide that is higher than that obtained by dissolving solid zinc oxide in aqueous sodium or potassium hydroxide, wherein the concentration of the aqueous sodium or potassium hydroxide used for dissolving the solid zinc oxide is substantially the same as the concentration of the aqueous sodium or potassium hydroxide in the resulting dilute solution of zinc oxide, and wherein the concentration of the aqueous sodium hydroxide in the resulting dilute solution ranges from 5 wt % NaOH to 35 wt % NaOH or wherein the concentration of the aqueous potassium hydroxide in the resulting dilute solution ranges from 10 wt % KOH to 55 wt % KOH.

Preferably the concentration of the aqueous sodium hydroxide in the resulting dilute solution ranges from 10 wt % NaOH to 35 wt % NaOH, and more preferably from 15 wt % NaOH to 35 wt % NaOH.

Preferably the concentration of the aqueous potassium hydroxide in the resulting dilute solution ranges from 10 wt % KOH to 55 wt % KOH, and more preferably from 20 wt % KOH to 55 wt % KOH.

It is known that solubility of zinc oxide in aqueous base is limited and depends on temperature and base concentration. The present invention affords one the opportunity to increase the solubility of zinc oxide at low base concentrations. Thus the present invention is extremely useful, for example, in electrolytic processes converting zinc oxide to zinc metal, wherein it is highly desirable to achieve higher volume efficiency.

As such, the present invention also provides a process for producing zinc metal comprising electrolyzing a basic solution of zinc oxide prepared by the aforementioned process. The electrolysis can be carried out at a wide range of current densities, and in one embodiment from 500 to 20,000 amps/m².

Volume efficiency depends on the solubility of ZnO. Normal solubility increases nonlinearly when base concentration (such as NaOH or KOH) is increased. In order to achieve high volume efficiency, ZnO concentration in the electrolyte should be as high as possible. However, high base concentration can lead to a significant increase in stainless steel based anode corrosion. Hence it is desirable to have electrolytes with lower base concentration and higher ZnO concentration. The presently claimed zinc oxide compositions and zinc compositions prepared by the presently claimed processes-viz., diluting a concentrated ZnO solution contain significantly more ZnO than the solutions prepared by dissolving solid ZnO in a basic solution containing the desired base concentration to make a saturated solution.

The compositions of the present invention, and compositions made by the presently claimed processes are relatively stable. For example, a solution containing 10 wt % NaOH is stable at room temperature for more than 24 hours. Solutions containing higher sodium hydroxide concentrations are more stable. However, stability decreases when NaOH concentration is decreased. For example, the stability of a solution containing 5 wt % base concentration is less than 30 minutes at room temperature. Stability of these solutions increases when they are stored at lower temperatures.

The following specific examples will provide detailed illustrations of the methods of producing and utilizing compositions of the present invention. These examples are not intended, however, to limit or restrict the scope of the invention in any way and should not be construed as providing conditions, parameters or values which must be utilized exclusively in order to practice the present invention. Unless otherwise specified, all parts and percents are by weight. The following abbreviations are used: g=grams; kg=kilograms; wt %=weight percent.

### EXAMPLES

### Reference Examples 1-2

Preparation of basic solution of zinc oxide by normal solubilization (dissolving solid zinc oxide in aqueous sodium hydroxide):

### Reference Example 1

Solid zinc oxide (10.0 grams) is dissolved in 990.0 grams of a 10.1 wt % aqueous sodium hydroxide solution by heating the slurry at 80 to 90° C. to give a saturated solution of zinc oxide that has a sodium hydroxide concentration of 10.0 wt % and a zinc oxide concentration of 1.0 wt %. The ZnO and NaOH are still in solution even after cooling to room temperature.

### Reference Example 2

Solid zinc oxide (29.9 grams) is dissolved in 468.2 grams of a 26.6 wt % aqueous sodium hydroxide solution by heating the slurry at 80 to 90° C. to give a saturated solution of zinc oxide that has a sodium hydroxide concentration of 25 wt % and a zinc oxide concentration of 6.0 wt %. The ZnO and NaOH are still in solution even after cooling to room temperature.

### Examples 1-2

Preparation of basic solution of zinc oxide by the method of the present invention (diluting a more concentration solution of zinc oxide in aqueous sodium hydroxide):

### Example 1

An aqueous solution containing 20.0 wt % zinc oxide and 40 wt % sodium hydroxide is diluted 4 fold (by weight) by adding 150 g water to 50.0 g of the solution in a 250 ml beaker. The resulting diluted solution contains 10.0 wt % sodium hydroxide and 5.0 wt % zinc oxide. This represents approximately a five-fold increase in the solubility of zinc oxide (5.0 wt % vs. 1.0 wt % in Reference Example 1) at about the same concentration of sodium hydroxide (10 wt %).

### Example 2

A solution containing 20.0 wt % zinc oxide and 40 wt % sodium hydroxide is diluted 1.6 fold (by weight) by adding 50.0 g of the solution to 30.0 g water in a 100 ml beaker. The resulting diluted solution contains 25.0 wt % sodium hydroxide and 12.5 wt % zinc oxide. This represents approximately a two-fold increase in the solubility of zinc oxide (12.5 wt % vs. 6.0 wt % in Reference Example 2) at about the same concentration of sodium hydroxide (25 wt %).

### Example 3

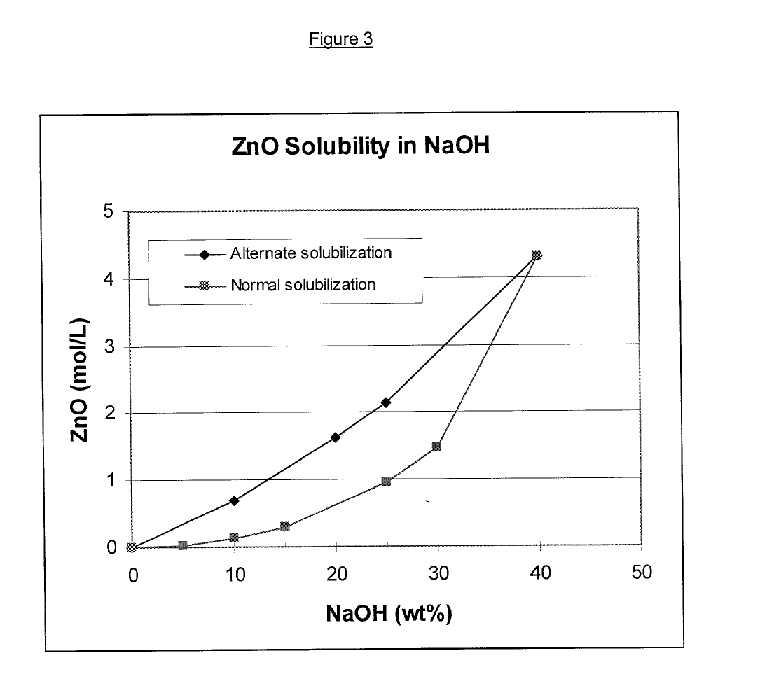

FIG. 3 is a plot of zinc oxide solubility at various concentrations of sodium hydroxide. Both the solubility obtained by normal solubilization (i.e., dissolving solid zinc oxide in aqueous sodium hydroxide to obtain a saturated solution of zinc oxide) and the solubility obtained by the presently claimed method (diluting a more concentrated solution of zinc oxide to give a resulting diluted solution that has approximately the same sodium hydroxide concentration as that obtained by normal solubilization but has a substantially higher concentration of zinc oxide than that obtained by normal solubilizaton).

### Example 4

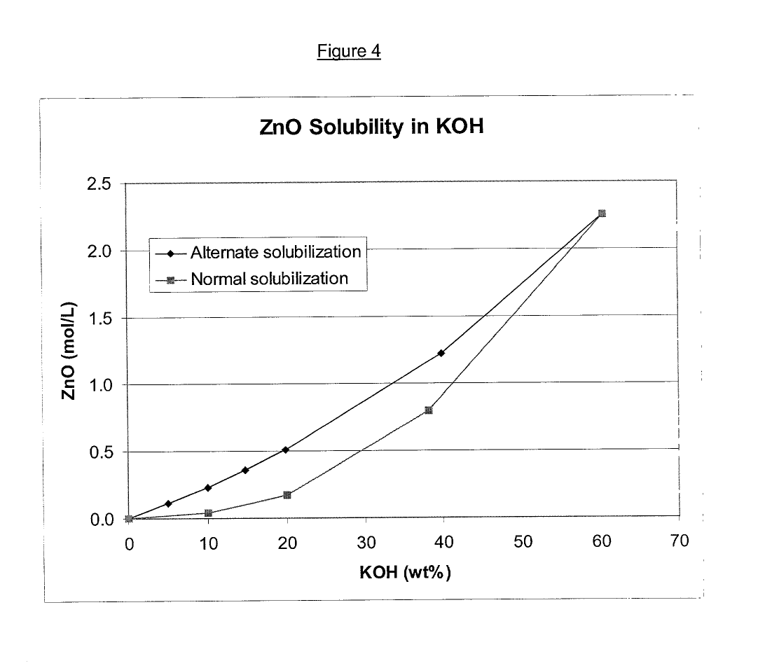

FIG. 4 is a plot of zinc oxide solubility at various concentrations of potassium hydroxide. Both the solubility obtained by normal solubilization (i.e., dissolving solid zinc oxide in aqueous potassium hydroxide to obtain a saturated solution of zinc oxide) and the solubility obtained by the presently claimed method (diluting a more concentrated solution of zinc oxide to give a resulting diluted solution that has approximately the same potassium hydroxide concentration as that obtained by normal solubilization but has a substantially higher concentration of zinc oxide than that obtained by normal solubilizaton).

### Reference Examples 5-6

Electrolysis of basic solution of zinc oxide prepared by normal solubilization:

### Reference Example 5

A 4-liter (L) resin Kettle (4 inch in diameter and 18 inch high) was used as the cell. A saturated solution of ZnO (3750 g, 3.46 liters) was prepared by heating (80-90° C.) with stirring a slurry of ZnO (37.5 g) in 10.1 wt. % sodium hydroxide solution (3712.5 g). The resulting solution containing 10.0 wt. % NaOH and 1.0 wt. % ZnO was charged into the resin kettle. A thermometer, stainless steel anode and a magnesium cathode were positioned in the cell using laboratory clamps. Mixing was achieved by using a mechanical stirrer with blades situated near the bottom of the reactor. Parts of the cathode and anode surfaces were covered with Teflon tape to achieve the desired active cathode and anode surface areas. Electrolysis was carried out at a current density of 5000 amps/m². A portion of the zinc deposited on the cathode was removed periodically. After passing 80100 coulombs, zinc particles were separated from the electrolyte by decantation, washed with 20 wt. % NaOH solution, water, and then methanol respectively. They were then dried under nitrogen to give 16.4 g of the dried zinc particles. The dried zinc particles were shown to contain 16.4 g zinc. No corrosion of stainless steel was observed. Current efficiency of this electrolysis was 60.5%, and the volume efficiency was 4.74 g Zn/liter of electrolyte.

### Reference Example 6

A 4-liter (L) resin Kettle (4 inch in diameter and 18 inch high) was used as the cell. A saturated solution of zinc oxide was prepared by heating (80-90° C.) with stirring a slurry of ZnO (299 g) in 26.6 wt % sodium hydroxide solution (4682 g). The resulting solution (4981 g, 3.77 liters) containing 25.0 wt. % sodium hydroxide and 6.0 wt. % zinc oxide was charged into the resin kettle. A thermometer, stainless steel anode and a magnesium cathode were positioned in the cell using laboratory clamps. Mixing was achieved by using a mechanical stirrer with blades situated near the bottom of the reactor. Parts of the cathode and anode surfaces were covered with Teflon tape to achieve the desired active cathode and anode surface areas. Electrolysis was carried out at a current density of 5000 amps/m². A portion of the zinc deposited on the cathode was removed periodically. After passing 353,400 coulombs, zinc particles were separated from the electrolyte by decantation, washed with 20 wt % NaOH solution, water, and then methanol respectively. It was then dried under nitrogen to give 132.1 g of partially dried zinc particles which contained 106.5 g of zinc. Current efficiency for the electrolysis was 89%. Volume efficiency of this process was 28.3 g Zn/liter of electrolyte.

### Examples 5-6

Electrolysis of basic solution of zinc oxide prepared by the method of this invention:

### Example 5

A 1-liter (L) beaker was used as the cell. A saturated solution of zinc oxide in the aqueous sodium hydroxide solution was prepared by heating (80-90° C.) with stirring a slurry of ZnO (500 g) in 50 wt % sodium hydroxide solution (2000 g). This solution (187.5 g) was then diluted with water and the resulting solution (750 g, 0.66 liters) containing 10 wt % sodium hydroxide and 5 wt % ZnO was then charged into the cell. A thermometer, stainless steel anode and a magnesium cathode were positioned in the cell using laboratory clamps. Mixing was achieved by using a mechanical stirrer with blades situated near the bottom of the reactor. Parts of the cathode and anode surfaces were covered with Teflon tape to achieve the desired active cathode and anode surface areas. Electrolysis was carried out at a current density of 5000 amps/m². A portion of the zinc deposited on the cathode was removed periodically. After passing 80100 coulombs, zinc particles were separated from the electrolyte by decantation, washed with 20 wt % NaOH solution, water, and then methanol respectively. The particles were then dried under nitrogen to give 28.1 g of partially dried zinc particles, which were shown to contain 25.2 g zinc. The current efficiency of the electrolysis was 93%, and the volume efficiency was 38.2 g Zn/liter of electrolyte. This indicates an improvement in volume efficiency over the electrolytic process carried out using a basic zinc oxide solution prepared by the normal solubilization method (Reference Example 5, having a volume efficiency of 4.74 g Zn/liter of electrolyte).

### Example 6

A 4-liter (L) resin Kettle (4 inch in diameter and 18 inch high) was used as the electrolytic cell. A saturated solution of zinc oxide in the aqueous sodium hydroxide solution was prepared by heating (80-90° C.) with stirring a slurry of ZnO (636.8 g) in 50 wt % sodium hydroxide solution (2547 g). This solution (3183.8 g) was then diluted with water and the resulting solution (5094 g, 3.64 liters) containing 25 wt % sodium hydroxide and 12.5 wt % ZnO was then charged into the cell. A thermometer, stainless steel anode and a magnesium cathode were positioned in the cell using laboratory clamps. Mixing was achieved by using a mechanical stirrer with blades situated near the bottom of the reactor. Parts of the cathode and anode surfaces were covered with Teflon tape to achieve the desired active cathode and anode surface areas. Electrolysis was carried out at a current density of 5000 amps/m². A portion of the zinc deposited on the cathode was removed periodically. After passing 1,147,400 coulombs, zinc particles were separated from the electrolyte by decantation, washed with 20 wt % NaOH solution, water, and methanol respectively. The particles were then dried under nitrogen to give partially dried zinc particles (402.6 g), which contained 343.8 g of zinc. Current efficiency for the electrolysis was 88.5%. Volume efficiency of this process was 94.5 g Zn/liter of electrolyte. This indicates an improvement in volume efficiency over the electrolytic process carried out using a basic zinc oxide solution prepared by the normal solubilization method (Reference Example 6, having a volume efficiency of 28.3 g Zn/liter of electrolyte).

A summary of the data of Examples 5 and 6, and Reference Examples 5, and 6, showing the advantages of the present invention in terms of volume efficiency are shown in Table 1.

TABLE 1

| | | Volume | | | |
|---|---|---|---|---|---|
| | | Efficiency | | | |
| NaOH | ZnO | (Grams of | Current | Corrosion | |
| Conc. | Conc. | Zn/liter of | Efficiency | (g/45.4 kg of | Solubilization |
| (wt. %) | (wt %) | electrolyte) | % | Zn) | process |
| 10 | 1.0 | 4.74 | 60.5 | 0.0 | Normal solubilization |
| 10 | 5.0 | 38.2 | 93.0 | 1.0 | Present invention |
| 25 | 6.0 | 28.3 | 89.0 | 6.8 | Normal solubilization |
| 25 | 12.5 | 94.5 | 88.5 | 7.0 | Present invention |

Each of the documents referred to above is incorporated herein by reference in its entirety, for all purposes. Except in the Examples, or where otherwise explicitly indicated, all numerical quantities in this description specifying amounts and concentrations of materials, reaction and process conditions (such as temperature, current density), and the like are to be understood to be modified by the word “about”.

While the invention has been explained in relation to its preferred embodiments, it is to be understood that various modifications thereof will become apparent to those skilled in the art upon reading the specification. Therefore, it is to be understood that the invention disclosed herein is intended to cover such modifications as fall within the scope of the appended claims.

1. A composition comprising a saturated solution of zinc oxide in an aqueous sodium hydroxide solution wherein the concentrations of the zinc oxide and the sodium hydroxide in said solution are as set forth in FIG. 1.

2. A composition comprising a saturated solution of zinc oxide in an aqueous potassium hydroxide solution wherein the concentrations of the zinc oxide and the potassium hydroxide in said solution are as set forth in FIG. 2.

3. A process for preparing a solution of zinc oxide in an aqueous sodium hydroxide solution, said process comprising diluting a more concentrated solution of zinc oxide in aqueous sodium hydroxide to produce a resulting dilute solution of zinc oxide having a concentration of zinc oxide that is higher than that obtained by dissolving solid zinc oxide in aqueous sodium hydroxide, wherein the concentration of the aqueous sodium hydroxide used for dissolving the solid zinc oxide is substantially the same as the concentration of the aqueous sodium hydroxide in the resulting dilute solution of zinc oxide, and wherein the concentration of the aqueous sodium hydroxide in the resulting dilute solution ranges from about 5 wt % NaOH to about 35 wt % NaOH.

4. A process for preparing a basic solution of zinc oxide in an aqueous potassium hydroxide solution, said process comprising diluting a more concentrated solution of zinc oxide in aqueous potassium hydroxide to produce a resulting dilute solution of zinc oxide having a concentration of zinc oxide that is higher than that obtained by dissolving solid zinc oxide in aqueous potassium hydroxide, wherein the concentration of the aqueous potassium hydroxide used for dissolving the solid zinc oxide is substantially the same as the concentration of the aqueous potassium hydroxide in the resulting dilute solution of zinc oxide, and wherein the concentration of the aqueous potassium hydroxide in the resulting dilute solution ranges from about 10 wt % KOH to about 55 wt % KOH.

5. The process of claim 3, wherein the concentration of the aqueous sodium hydroxide in the resulting dilute solution ranges from about 10 wt % NaOH to about 35 wt % NaOH.

6. The process of claim 4, wherein the concentration of the aqueous potassium hydroxide in the resulting dilute solution ranges from about 20 wt % KOH to about 55 wt % KOH.

7. A process for producing zinc metal comprising electrolyzing a basic solution of zinc oxide prepared by the method of claim 3.

8. A process for producing zinc metal comprising electrolyzing a basic solution of zinc oxide prepared by the method of claim 4.

9. The process of claim 5, wherein the electrolysis is carried out at a current density of about 500 amps/m² to about 20,000 amps/m².
